(19) United States
(12) Patent Application Publication
(10) Pub. No.: US 2024/0088530 A1
(43) Pub. Date: Mar. 14, 2024

(54) BATTERY TAB STRUCTURE, BATTERY, AND TAB FILM CUTTING METHOD

(71) Applicant: TOYOTA JIDOSHA KABUSHIKI KAISHA, Toyota-shi Aichi-ken (JP)

(72) Inventor: Daisuke TAYAMA, Toyota-shi Aichi-ken (JP)

(73) Assignee: TOYOTA JIDOSHA KABUSHIKI KAISHA, Toyota-shi Aichi-ken (JP)

(21) Appl. No.: 18/242,587

(22) Filed: Sep. 6, 2023

(30) Foreign Application Priority Data
Sep. 12, 2022 (JP) 2022-144826

(51) Int. Cl. H01M 50/557; H01M 50/548; H01M 50/566

(52) U.S. Cl. CPC H01M 50/557; H01M 50/548; H01M 50/566

(57) ABSTRACT

A battery includes an electrode body, a charge collection terminal that contacts a side face on a first direction one side of the electrode body, a laminated sheet covering the electrode body and a portion of the charge collection terminal at another side in the first direction, and a tab film. The tab film is interposed between the charge collection terminal and the laminated sheet, is formed with a projection portion that protrudes out from a corner portion provided to the charge collection terminal at an end portion in a second direction orthogonal to the first direction and to a thickness direction of the charge collection terminal, and is welded to the charge collection terminal and the laminated sheet at a periphery of the charge collection terminal.

### CROSS-REFERENCE TO RELATED APPLICATION

This application is based on and claims priority under 35 USC 119 from Japanese Patent Application No. 2022-144826 filed on Sep. 12, 2022, the disclosures of which are incorporated by reference herein.

### BACKGROUND

### Technical Field

The present disclosure relates to a battery tab structure, a battery, and a tab film cutting method.

### Related Art

Japanese Patent Application Laid-Open (JP-A) No. 2011-108623 discloses technology related to a secondary battery. In this secondary battery, an electrode assembly body and an electrolyte are covered by a sealing section configured including an external cladding and a pair of covers.

However, in the related art of JP-A No. 2011-108623, the external cladding is fold-bent to cover a side face of an electrode assembly body, and the pair of covers cover end portions of the electrode assembly.

At a boundary portion between the external cladding and the covers, the external cladding is in a state covering an outside of the covers.

### SUMMARY

However, when a configuration such as described above is adopted, a gap might conceivably arise between corner portions of the fold-bent external cladding and the covers, with this conceivably resulting in communication between the inside and the outside of the battery.

In consideration of the above circumstances, an object of the present disclosure is to obtain a battery tab structure, a battery, and a tab film cutting method capable of suppressing communication between the inside and the outside of the battery.

A battery tab structure according to a first aspect includes a charge collection terminal and a tab film. The charge collection terminal has a plate shape and is configured including a contact portion that is capable of contacting a power supply target and that is disposed at a first direction one end side of a battery, and a base portion provided so as to be contiguous to the contact portion at a side of the contact portion toward a first direction center portion of the battery. The tab film is formed with a projection portion protruding out from a corner portion of the base portion provided at an end portion in a second direction orthogonal to the first direction and to a thickness direction of the charge collection terminal, and is disposed at a periphery of the base portion in a state of being welded to the base portion.

The battery tab structure according to the first aspect includes the plate shaped charge collection terminal configured including the contact portion and the base portion. The contact portion is disposed at the first direction one end side of the battery and is configured so as to be capable of contacting the power supply target.

The base portion is provided so as to be contiguous to the contact portion at a side of the contact portion toward the first direction center portion of the battery. The tab film is disposed at the periphery of the base portion in a state of being welded to the base portion.

However, when sticking an external cladding such as a laminated sheet or the like to the base portion from the outside of the tab film, depending on the way in which the external cladding is fold-bent, conceivably gaps might develop between corner portions of the fold-bent external cladding and the tab film.

Thus in the present disclosure, the projection portion is formed to the tab film, with the projection portion protruding out from the corner portion provided to the end portion of the base portion in the second direction orthogonal to the first direction and to a thickness direction of the charge collection terminal.

This means that in the present disclosure, due to the projection portion of the tab film entering into the corner portion of the fold-bent external cladding from the charge collection terminal side, a gap can be suppressed from developing between the corner portion of the fold-bent external cladding and the tab film.

A battery tab structure according to a second aspect is the battery tab structure according to the first aspect, wherein the projection portion protrudes out from the corner portion in the second direction.

In the battery tab structure according to the second aspect, the projection portion of the tab film protrudes out in the second direction from the corner portion provided to the second direction end portion of the base portion. This means that when plural of the batteries are disposed superimposed on each other in a plate thickness direction of the charge collection terminal, the direction in which the batteries are superimposed is a direction different to the protrusion direction of the corner portion of the external cladding, with the projection portion of the tab film entered therein, thereby enabling the corner portion of the external cladding of one battery to be suppressed from interfering with the other battery.

A battery according to a third aspect includes an electrode body, a charge collection terminal that contacts a side face on a first direction one side of the electrode body, a laminated sheet covering the electrode body and a portion of the charge collection terminal at another side in the first direction, and a tab film. The tab film is interposed between the charge collection terminal and the laminated sheet, is formed with a projection portion that protrudes out from a corner portion provided at the charge collection terminal at an end portion in a second direction orthogonal to the first direction and to a thickness direction of the charge collection terminal, and is welded to the charge collection terminal and the laminated sheet at a periphery of the charge collection terminal.

In the battery according to the third aspect, the charge collection terminal contacts a side face on the first direction one side of the electrode body, and portions on the first direction other side of the electrode body and the charge collection terminal are covered by the laminated sheet. The tab film is interposed between the charge collection terminal and the laminated sheet, with the tab film welded to the charge collection terminal and the laminated sheet at the periphery of the charge collection terminal.

In the present disclosure, similarly to the battery tab structure according to the first aspect, the projection portion is formed to the tab film protruding out from the corner portion provided to the second direction end portion of the charge collection terminal. Thus due to the projection portion of the tab film entering into the corner portion of the fold-bent laminated sheet from the charge collection terminal side, a gap can be suppressed from developing between the corner portion of the fold-bent laminated sheet and the tab film.

A tab film cutting method according to a fourth aspect includes: disposing a first film above a plate-shaped charge collection terminal; disposing an upper jig above the first film; disposing a second film below the charge collection terminal; disposing a lower jig below the second film; disposing a first lateral jig provided with first projection portions protruding in upward and downward directions at one side with respect to the charge collection terminal in a second direction orthogonal to a thickness direction of the charge collection terminal as viewed along the first direction and to the first direction; temporarily fixing a third film to a portion of the first lateral jig at another side in the second direction such that the third film is in a curved or bent state so as to be convex on a charge collection terminal side; disposing a second lateral jig provided with second projection portions protruding in the upward and the downward directions at the other side in the second direction with respect to the charge collection terminal; and in a state in which a fourth film is temporarily fixed to a portion of the second lateral jig at the second direction one side such that the fourth film is in a curved or bent state so as to be convex on the charge collection terminal side, pressing with a hot press from above the upper jig and below the lower jig.

In the tab film cutting method according to the fourth aspect, the first film is disposed above the plate shaped charge collection terminal, and the upper jig is disposed above the first film. Moreover, the second film is disposed below the charge collection terminal, and the lower jig is disposed below the second film.

The first lateral jig provided with the first projection portions protruding toward the top and bottom of the charge collection terminal is disposed at one side with respect to the charge collection terminal in the second direction orthogonal to the thickness direction of the charge collection terminal as viewed along the first direction and to the first direction. The third film is then temporarily fixed to the portion of the first lateral jig at the second direction other side such that the third film is in a curved or bent state so as to be convex on the charge collection terminal side.

The second lateral jig provided with second projection portions protruding toward the top and bottom of the charge collection terminal is disposed at the second direction other side with respect to the charge collection terminal. The fourth film is temporarily fixed to the second direction one side portion of the second lateral jig such that the fourth film is in a curved or bent state so as to be convex on the charge collection terminal side.

Then in the present disclosure, the first film, the second film, the third film, and the fourth film are integrated together by pressing with the hot press from above the upper jig and from below the lower jig in the above described state, so as to configure the tab film at the periphery of the charge collection terminal.

Moreover, when pressing with the hot press, the first film and the third film are sandwiched by the upper jig and the first projection portion on the upper jig side, such that the projection portion is formed to the tab film so as to be thinned on progression toward the second direction one side. Excess portions of the first film and the third film at the second direction one side of the projection portion are melted by heat from the hot press and severed.

Similarly, the first film and the fourth film are sandwiched by the upper jig and the second projection portion on the upper jig side such that the projection portion is formed to the tab film so as to be thinned on progression toward the second direction other side. Excess portions of the first film and the fourth film at the second direction other side of the projection portion are melted by heat from the hot press and severed.

Moreover, during pressing with the hot press, the second film and the third film are sandwiched by the lower jig and the first projection portion at the lower jig side such that the projection portion is formed to the tab film so as to be thinned on progression toward the second direction one side. Excess portions of the second film and the third film at the second direction one side of the projection portion are melted by heat from the hot press and severed.

Similarly, the second film and the fourth film are sandwiched by the lower jig and the second projection portion on the lower jig side, such that the projection portion is formed to the tab film so as to be thinned on progression toward the second direction other side. Excess portions of the second film and the fourth film at the second direction other side of the projection portion are melted by heat from the hot press and severed.

Due to the projection portions being formed to the tab film in the manner described above, the projection portions of the tab film enter from the charge collection terminal side into the corner portions of the external cladding, such as a laminated sheet or the like stuck to the charge collection terminal from the outside of the tab film. The present disclosure is thereby able to suppress gaps from developing between the corner portions of the fold-bent external cladding and the tab film.

As described above, the battery tab structure, the battery, and the tab film cutting method according to the present disclosure exhibit the effect of enabling communication between the inside and the outside of the battery to be suppressed.

### BRIEF DESCRIPTION OF THE DRAWINGS

Exemplary embodiments of the present disclosure will be described in detail based on the following figures, wherein:

FIG. 1 is an enlarged cross-section schematically illustrating a configuration of a relevant portion of a battery according to an exemplary embodiment (an enlarged diagram of portions surrounded by a double-dot broken line in FIG. 2);

FIG. 2 is a cross-section schematically illustrating a configuration of a periphery of a battery tab according to the present exemplary embodiment (a cross-section illustrating a state sectioned along line 2-2 of FIG. 3);

FIG. 3 is a plan view schematically illustrating a configuration of a battery according to the present exemplary embodiment;

FIG. 4A is an explanatory diagram schematically illustrating an attachment process of a tab film in a battery according to the present exemplary embodiment, and illustrates a first process thereof;

FIG. 4B is an explanatory diagram schematically illustrating an attachment process of a tab film in a battery according to the present exemplary embodiment, and illustrates a second process thereof;

FIG. 4C is an explanatory diagram schematically illustrating an attachment process of a tab film in a battery according to the present exemplary embodiment, and illustrates a third process thereof;

FIG. 4D is an explanatory diagram schematically illustrating an attachment process of a tab film in a battery according to the present exemplary embodiment, and illustrates a fourth process thereof;

FIG. 5 is an enlarged cross-section illustrating a configuration of a jig employed in an attachment process of a tab film in a battery according to the present exemplary embodiment;

FIG. 6A is an explanatory diagram schematically illustrating an attachment process of a laminated sheet in a battery according to the present exemplary embodiment, and illustrates a first process thereof;

FIG. 6B is an explanatory diagram schematically illustrating an attachment process of a laminated sheet in a battery according to the present exemplary embodiment, and illustrates a second process thereof;

FIG. 6C is an explanatory diagram schematically illustrating an attachment process of a laminated sheet in a battery according to the present exemplary embodiment, and illustrates a third process thereof; and

FIG. 6D is an explanatory diagram schematically illustrating an attachment process of a laminated sheet in a battery according to the present exemplary embodiment, and illustrates a fourth process thereof.

### DETAILED DESCRIPTION

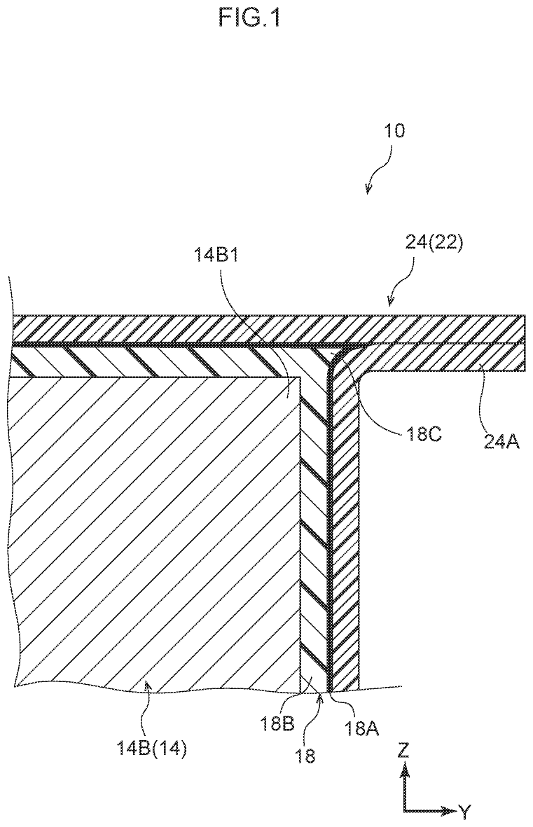

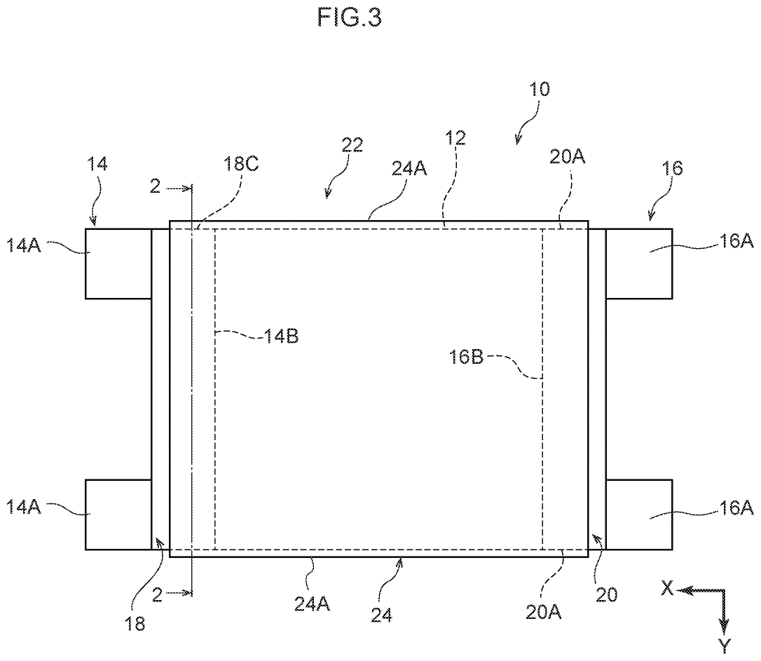

Explanation follows regarding an example of an exemplary embodiment of a “battery 10” applied with a battery tab structure according to the present disclosure, with reference to FIG. 1 to FIG. 6. As illustrated in FIG. 3, the battery 10 is, for example, configured as a laminated lithium ion secondary battery. Note that in the following a length direction of the battery 10 is called a first direction, a width direction of the battery 10 is called a second direction, and a thickness direction of the battery 10 is called a third direction. In each of the drawings the first direction is indicated by arrow X, the second direction is indicated by arrow Y, and the third direction is indicated by arrow Z.

The battery 10 includes an electrode body 12, a non-illustrated electrolyte layer, a “positive-electrode-side charge collection terminal 14”, a “negative-electrode-side charge collection terminal 16”, a “positive-electrode-side tab film 18”, a “negative-electrode-side tab film 20”, and an external cladding 22.

More specifically, the electrode body 12 is a stacked electrode body configured by plural sheets of non-illustrated sheet shaped positive electrode bodies and plural sheets of non-illustrated sheet shaped negative electrode bodies stacked along the third direction. Note that the positive electrode bodies and the negative electrode bodies are stacked alternately in a state insulated from each other. Moreover, a single positive electrode body and a single negative electrode body is also sufficient.

The positive electrode bodies each include a positive electrode charge collection body, and a positive electrode active material layer provided on a surface thereof. Aluminum is, for example, employed as the material for the positive electrode charge collection body. Moreover, a positive electrode active material (for example, a lithium-transition metal composite oxide such as a lithium-nickel-cobalt-manganese composite oxide or the like) is contained in the positive electrode active material layer.

The negative electrode bodies each include a negative electrode charge collection body, and a negative electrode active material layer provided on a surface thereof. Note that copper may, for example, be employed as the material for the negative electrode charge collection body. A negative electrode active material (such as a carbon material of graphite or the like) is contained in the negative electrode active material layer.

Furthermore, a non-illustrated positive electrode charge collection tab and a negative electrode charge collection tab are provided to the electrode body 12. More specifically, the positive electrode charge collection tab is configured by a portion of the positive electrode charge collection body being extended toward a first direction one side, with an end face on a first direction one side of the positive electrode charge collection tab in a state of contact with the positive-electrode-side charge collection terminal 14. Namely, the end face on the first direction one side of the positive electrode charge collection tab can be thought of configuring a side face on a first direction one side of the electrode body 12. Note that the positive electrode active material layer is not provided on the positive electrode charge collection tab.

The negative electrode charge collection tab is configured by a portion of the negative electrode charge collection body being extended toward the first direction other side, with an end face on a first direction other side of the negative electrode charge collection tab being in a state of contact with the negative-electrode-side charge collection terminal 16. Namely, an end face on the first direction other side of the negative electrode charge collection tab can be thought of as configuring a side face on a first direction other side of the electrode body 12. Note that the negative electrode active material layer is not provided on the negative electrode charge collection tab.

Although a liquid electrolyte layer, a gel electrolyte layer, a solid electrolyte layer, or the like may all be employed as the electrolyte layer, in the present exemplary embodiment, as an example, the electrolyte layer is configured by a solid electrolyte layer including a solid electrolyte, with most of the electrolyte layer interposed between the positive electrode active material layer and the negative electrode active material layer. Note that the type of solid electrolyte is not particularly limited, as long as it has ion conductivity.

In cases in which a liquid electrolyte layer is employed, a separator may be interposed between the positive electrode body and the negative electrode body to insulate between the positive electrode active material layer and the negative electrode active material layer. Moreover, sheet materials etc. configured from a resin such as polyethylene (hereafter referred to as PE), polypropylene (hereafter referred to as PP), or the like may, for example, be employed as such a separator.

The positive-electrode-side charge collection terminal 14 is made from aluminum and has a thin plate shape with a plate thickness direction in the third direction. The positive-electrode-side charge collection terminal 14 is configured including a pair of “contact portions 14A” disposed at a first direction one end side of the battery 10, and a “base portion 14B” provided so as to be contiguous to the contact portions 14A at a side of the contact portions 14A toward a first direction center portion of the battery 10.

The contact portions 14A are able to make contact with a non-illustrated power supply target, in a configuration such that electrical power from the battery 10 is supplied through the contact portions 14A to the power supply target.

However, the base portion 14B is joined to the positive electrode charge collection tab by resistance welding or the like at a non-illustrated junction portion in a state in which an end face on the first direction other side of the base portion 14B makes contact with an end face on the first direction one side of the positive electrode charge collection tab.

The negative-electrode-side charge collection terminal 16 is made from copper in a thin plate shape configured with a plate thickness direction in the third direction. The negative-electrode-side charge collection terminal 16 is configured including a pair of “contact portions 16A” disposed at a first direction other end side of the battery 10, and a “base portion 16B” provided so as to be contiguous to the contact portions 16A at a side of the contact portions 16A toward a first direction center portion of the battery 10.

The contact portions 16A are able to make contact with the non-illustrated power supply target, in a configuration such that electrical power from the battery 10 is supplied through the contact portions 16A to the power supply target.

The base portion 16B is joined to the negative electrode charge collection tab by resistance welding or the like at a non-illustrated junction portion in a state in which an end face on the first direction one side of the base portion 16B makes contact with an end face on the first direction other side of the negative electrode charge collection tab.

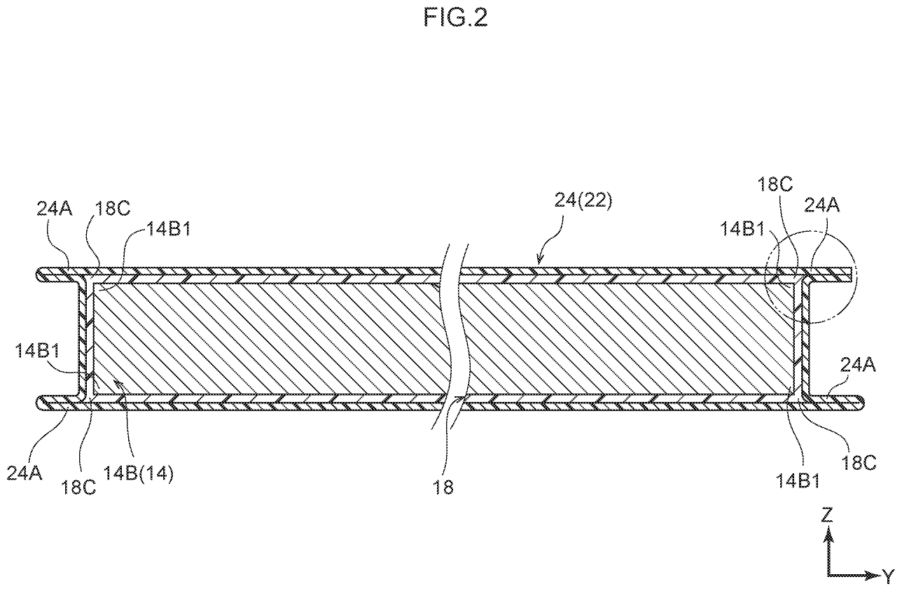

As illustrated in FIG. 1 and FIG. 2, the positive-electrode-side tab film 18 is disposed tightly adhered to a periphery of the base portion 14B of the positive-electrode-side charge collection terminal 14. The positive-electrode-side tab film 18 has an overall quadrilateral tube shape with an axial direction in the first direction, and is configured including a surface layer 18A configuring a portion on the surface side of the positive-electrode-side tab film 18, and a welded layer 18B configuring a portion on the base portion 14B side thereof and welded to the base portion 14B.

Note that the surface layer 18A is configured from a resin such as polyethylene terephthalate (hereafter referred to as PET) that has water resistance properties, moisture barrier properties, and gas barrier properties, and the welded layer 18B is configured from a resin such as PP that has thermal welding properties.

In the present exemplary embodiment the positive-electrode-side tab film 18 is formed with four “projection portions 18C” to the positive-electrode-side tab film 18 in a cross-section viewed along the first direction. More specifically, the projection portions 18C are provided for each “corner portion 14B1”, at an end portion on one side in the second direction and an end portion on another side in the second direction of the base portion 14B of the positive-electrode-side charge collection terminal 14.

The projection portions 18C provided to the corner portions 14B1 on the second direction one side protrude from the corner portions 14B1 toward the second direction one side, and become thinner on progression toward the second direction one side.

The projection portions 18C provided for the corner portions 14B1 on the second direction other side protrude from the corner portions 14B1 toward the second direction other side, and become thinner on progression toward the second direction other side.

The negative-electrode-side tab film 20 is configured similarly to the positive-electrode-side tab film 18, and is disposed tightly adhered to a periphery of the base portion 16B of the negative-electrode-side charge collection terminal 16. More specifically, although not illustrated in the drawings, there are also four “projection portions 20A” provided to the negative-electrode-side tab film 20 similarly to the positive-electrode-side tab film 18.

A main portion of the external cladding 22 is configured by fold-bending a single sheet of “laminated sheet 24” into a quadrilateral tube shape having an axial direction in the first direction, and although not illustrated in the drawings, is more specifically configured from a protection layer, a metal layer, and a welded layer stacked in this sequence from the outside of the battery 10.

Note that the protection layer may be configured from a resin such as Nylon, PET, or the like, the metal layer may be configured from aluminum or stainless steel, and the welded layer may be configured from a resin such as PP, PE, or the like.

Moreover, in the present exemplary embodiment there are four corner portions 24A formed to the laminated sheet 24 in a cross-section of the laminated sheet 24 viewed along the first direction by fold-bending the laminated sheet 24. Namely, the four corner portions 24A are formed at the respective four corner portions of the quadrilateral tube shaped laminated sheet 24 by the laminated sheet 24 being folded back on itself at both end portions thereof in the second direction Y, such that the laminated sheet 24 is disposed along outside faces of the positive-electrode-side tab film 18 and the negative-electrode-side tab film 20 where they are disposed along the third direction Z, with the four corner portions 24A formed at each base end of the laminated sheet 24 where it is doubled up by being folded back. Projection portions 18C of the positive-electrode-side tab film 18 or projection portions 20A of the negative-electrode-side tab film 20 each enter inside these corner portions 24A (a side thereof where the positive-electrode-side tab film 18 and the negative-electrode-side tab film 20 are respectively disposed).

### Operation and Effects of Present Exemplary Embodiment

Next, description follows regarding the operation and effects of the present exemplary embodiment.

As illustrated in FIG. 3, the present exemplary embodiment includes the plate shaped positive-electrode-side charge collection terminal 14 configured including the contact portions 14A and the base portion 14B. The contact portions 14A are disposed at the first direction one end side of the battery 10 so as to be able to contact the power supply target.

The base portion 14B is provided so as to be contiguous to the contact portions 14A at a side of the contact portions 14A toward a first direction center portion of the battery 10. The positive-electrode-side tab film 18 is disposed at a periphery of the base portion 14B in a state welded to the base portion 14B.

When sticking an external cladding such as a laminated sheet or the like to the base portion 14B from the outside of the positive-electrode-side tab film 18, depending on the way in which the external cladding is fold-bent, conceivably gaps might develop between corner portions of the fold-bent external cladding and the positive-electrode-side tab film 18.

To address this issue, as illustrated in FIG. 1, in the present exemplary embodiment projection portions 18C are formed to the positive-electrode-side tab film 18, and the projection portions 18C protrude out from the corner portions 14B1 provided at second direction end portions of the base portion 14B.

This means that in the present exemplary embodiment, due to the projection portions 18C of the positive-electrode-side tab film 18 entering the corner portions 24A of the fold-bent laminated sheet 24 from the positive-electrode-side charge collection terminal 14 side thereof, gaps can be suppressed from developing between the corner portions 24A of the fold-bent laminated sheet 24 and the positive-electrode-side tab film 18.

Moreover, in the present exemplary embodiment the projection portions 18C of the positive-electrode-side tab film 18 protrude from the corner portions 14B1 provided at the second direction end portions of the base portion 14B in the second direction. This means that when plural of the batteries 10 are disposed superimposed on each other in the third direction, the direction in which the batteries 10 are superimposed is a direction different to the protrusion direction of the corner portions 24A of the laminated sheet 24, with the projection portions 18C of the positive-electrode-side tab film 18 entered therein. This thereby enables the corner portions 24A of the laminated sheet 24 of one of the batteries 10 to be suppressed from interfering with the other of the batteries 10.

Note that the operation and effects described above are similarly exhibited between the negative-electrode-side tab film 20 and the laminated sheet 24.

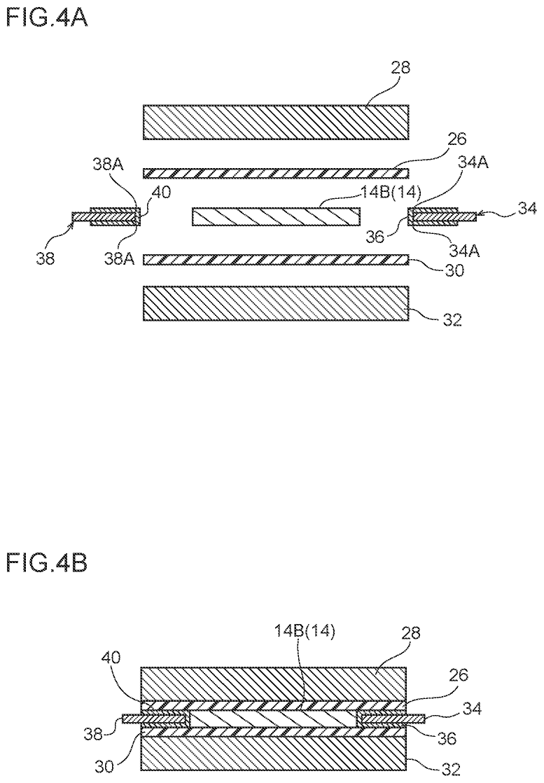

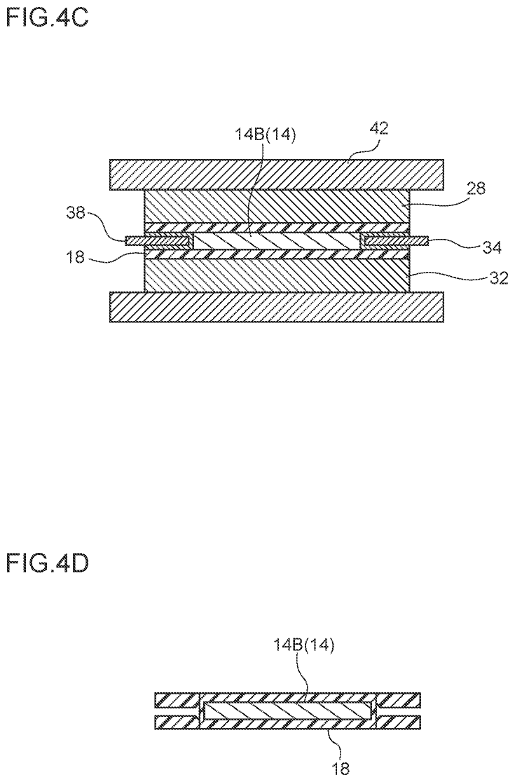

Next, description follows regarding an attachment process of the positive-electrode-side tab film 18 and the negative-electrode-side tab film 20, and an attachment process of the laminated sheet 24, with reference to FIG. 4A to FIG. 6D. Note that the attachment process of the positive-electrode-side tab film 18, and the attachment process of the negative-electrode-side tab film 20, are similar processes to each other, and so only the attachment process of the positive-electrode-side tab film 18 will be described for the attachment processes of the positive-electrode-side tab film 18 and the negative-electrode-side tab film 20.

In the attachment process of the positive-electrode-side tab film 18, in a first process illustrated in FIG. 4A, a “first film 26” on a third direction upper side of the base portion 14B of the positive-electrode-side charge collection terminal 14 is disposed such that a PET layer thereof is on the opposite side to that of the positive-electrode-side charge collection terminal 14. A plate shaped “upper jig 28” is then disposed so as to cover the base portion 14B at the third direction upper side of the first film 26 as viewed along the third direction.

A “second film 30” is disposed at a third direction lower side of the base portion 14B such that a PET layer thereof is on the opposite side to that of the positive-electrode-side charge collection terminal 14. A plate shaped “lower jig 32” is then disposed so as to cover the base portion 14B at the third direction lower side of the second film 30 as viewed along the third direction.

A “first lateral jig 34” having a plate shape with a thickness in the third direction that is about the same as a thickness in the third direction of the base portion 14B is disposed at the second direction one side with respect to the base portion 14B.

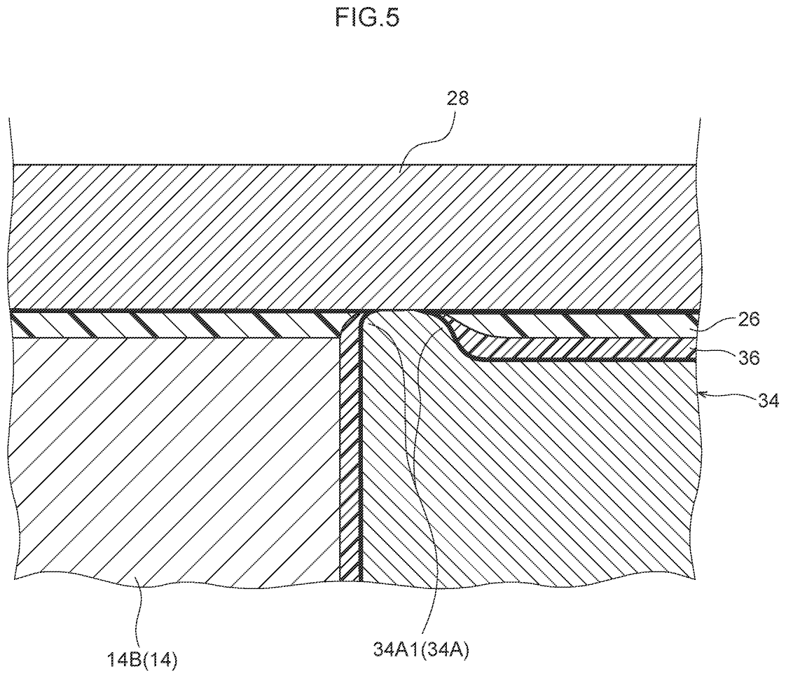

As illustrated in FIG. 5, “projection portions 34A” protruding in the third direction are provided as a pair of first projection portions at second direction other side end portions of the first lateral jig 34. More specifically, the projection portions 34A are configured with corner portions 34A1 having a rounded face or beveled face state at a second direction one side and a second direction other side thereof.

A “third film 36” is then temporarily fixed to a portion on the second direction other side of the first lateral jig 34, in a state in which the third film 36 is curved or bent so as to be convex on the positive-electrode-side charge collection terminal 14 side, and in a state in which a PET layer thereof is on the opposite side to that of the positive-electrode-side charge collection terminal 14 side.

Moreover, a “second lateral jig 38” configured similarly to the first lateral jig 34 is disposed at the second direction other side with respect to the base portion 14B. Note that when doing so a pair of “projection portions 38A” serving as second projection portions provided to the second lateral jig 38 are positioned at the positive-electrode-side charge collection terminal 14 side.

Then a “fourth film 40” is temporarily fixed to a portion on the second direction one side of the second lateral jig 38, in a state in which the fourth film 40 is curved or bent so as to be convex on the positive-electrode-side charge collection terminal 14 side, and in a state in which a PET layer thereof is on the opposite side to that of the positive-electrode-side charge collection terminal 14 side.

Next, in a second process illustrated in FIG. 4B, the upper jig 28, the lower jig 32, the first lateral jig 34, and the second lateral jig 38 are disposed at specific positions. Then in this state, the first film 26 and the second film 30 are each in a state of contact with the third film 36 and the fourth film 40.

Next, in a third process illustrated in FIG. 4C, a “hot press 42” is employed to press inward from the third direction upper side of the upper jig 28 and the third direction lower side of the lower jig 32. The first film 26, the second film 30, the third film 36, and the fourth film 40 are integrated together thereby so as to configure the positive-electrode-side tab film 18 at the periphery of the base portion 14B.

When this is being performed, the first film 26 and the third film 36 are sandwiched by the upper jig 28 and the projection portion 34A at the upper jig 28 side, and the projection portion 18C is formed to the positive-electrode-side tab film 18 so as to be thinned on progression toward the second direction one side. A boundary portion between the projection portion 18C and excess portions of the first film 26 and the third film 36 on the second direction one side from the projection portions 18C is melted by heat from the hot press 42, resulting in a severed or thinned state.

Similarly, the first film 26 and the fourth film 40 are sandwiched by the upper jig 28 and the projection portion 38A at the upper jig 28 side, and the projection portion 18C is formed to the positive-electrode-side tab film 18 so as to be thinned on progression toward the second direction other side. Then a boundary portion between these projection portion 18C and excess portions of the first film 26 and the fourth film 40 on the second direction other side from the projection portions 18C is melted by heat from the hot press 42, resulting in a severed or thinned state.

When this is being performed, the second film 30 and the third film 36 are sandwiched by the lower jig 32 and the projection portions 34A at the lower jig 32 side, and the projection portion 18C is formed to the positive-electrode-side tab film 18 so as to be thinned on progression toward the second direction one side. Then a boundary portion between the projection portion 18C and excess portions of the second film 30 and the third film 36 on the second direction one side from the projection portions 18C is melted by heat from the hot press 42, resulting in a severed or thinned state.

Similarly, the second film 30 and the fourth film 40 are sandwiched by the lower jig 32 and the projection portions 38A of the lower jig 32, such that the projection portion 18C is formed to the positive-electrode-side tab film 18 so as to be thinned on progression toward the second direction other side. A boundary portion between the projection portion 18C and excess portions of the second film 30 and the fourth film 40 on the second direction other side from the projection portions 18C is then melted by heat from the hot press 42, resulting in a severed or thinned state.

Next, in a fourth process illustrated in FIG. 4D, the upper jig 28, the lower jig 32, the first lateral jig 34, and the second lateral jig 38 are taken away, and also the excess portions of the first film 26, the second film 30, the third film 36, and the fourth film 40 are removed from the positive-electrode-side tab film 18.

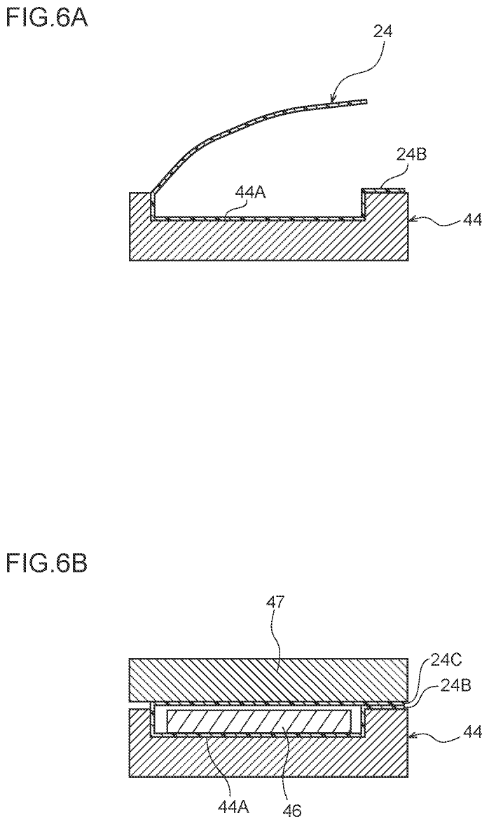

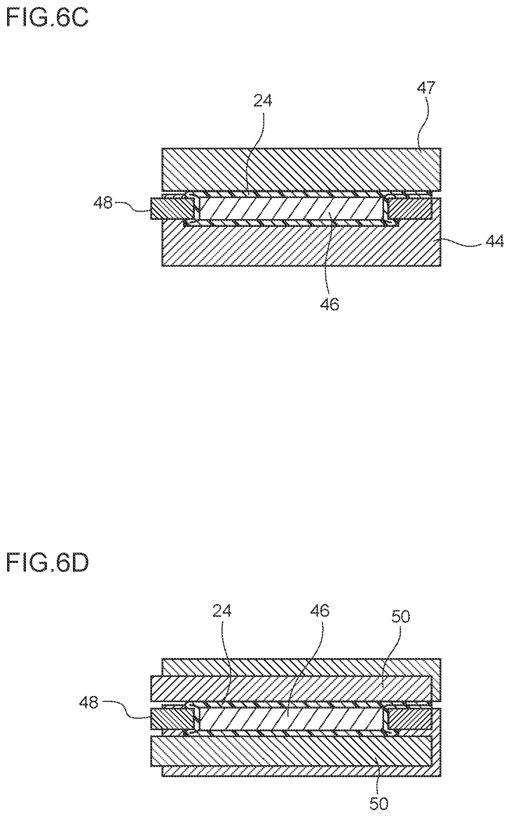

In the attachment process of the laminated sheet 24, the laminated sheet 24 is set with respect to a lower jig 44, in a first process illustrated in FIG. 6A. More specifically, about half of the laminated sheet 24 is pushed into a recess 44A provided in the lower jig 44 in a state in which a one end portion 24B of the laminated sheet 24 is placed on an upper face of the lower jig 44.

Next, in a second process illustrated in FIG. 6B, a composite body 46, resulting from the electrode body 12, the electrolyte layer, the positive-electrode-side charge collection terminal 14, the negative-electrode-side charge collection terminal 16, the positive-electrode-side tab film 18, and the negative-electrode-side tab film 20 being integrated together, is disposed inside the recess 44A such that the composite body 46 is positioned above the laminated sheet 24. An upper jig 47 is then disposed above the lower jig 44 in a state in which about half of the laminated sheet 24 covers an upper side by the composite body 46, and in a state in which another end portion 24C of the laminated sheet 24 is above the one end portion 24B.

Next, at a third process illustrated in FIG. 6C, the laminated sheet 24 is pushed in the second directions by a clamp 48 toward the composite body 46 side.

Next, in a fourth process illustrated in FIG. 6D, the laminated sheet 24 is pressed toward the composite body 46 side by a heat bar 50 from the third direction upper side and the third direction lower side at first direction both end portions of the composite body 46, so as to weld the laminated sheet 24 to the composite body 46.

When this is being performed, as illustrated in FIG. 1, at a first direction one end portion side of the composite body 46, the projection portions 18C of the positive-electrode-side tab film 18 enter into the corner portions 24A of the laminated sheet 24 from the positive-electrode-side charge collection terminal 14 side. Similar also occurs between the negative-electrode-side tab film 20 and the laminated sheet 24. The present exemplary embodiment is thereby able to suppress gaps from developing between the corner portions 24A of the fold-bent laminated sheet 24 and the positive-electrode-side tab film 18 and the negative-electrode-side tab film 20.

As described above, the present exemplary embodiment is able to suppress communication between the inside and the outside of the battery 10.

### Supplementary Description of Above Exemplary Embodiment

(1) Although in the exemplary embodiment described above the projection portions of the tab film protrude out in the second direction from the corner portions provided at a second direction end portions of the base portion of the charge collection terminal, depending on the specification and the like of the battery 10, the projection portions of the tab film may be configured so as to protrude out in the third direction.

(2) Moreover, although in the exemplary embodiment described above there are four projection portions provided for a single tab film, the configuration of the tab film is not limited thereto. For example, in cases in which a laminated sheet is curved around at locations where the corner portions provided to a second direction end portion of the base portion of the charge collection terminal are rounded off, a configuration may be adopted in which projection portions are not provided at corner portions of the tab film corresponding to such locations.

What is claimed is:

1. A battery tab structure comprising:
a charge collection terminal having a plate shape and configured including a contact portion that is capable of contacting a power supply target and that is disposed at a first direction one end side of a battery, and a base portion provided so as to be contiguous to the contact portion at a side of the contact portion toward a first direction center portion of the battery; and
a tab film that is formed with a projection portion protruding out from a corner portion of the base portion provided at an end portion in a second direction orthogonal to the first direction and to a thickness direction of the charge collection terminal, and that is disposed at a periphery of the base portion in a state of being welded to the base portion.

2. The battery tab structure of claim 1, wherein the projection portion protrudes out from the corner portion in the second direction.

3. A battery comprising:
an electrode body;
a charge collection terminal that contacts a side face on a first direction one side of the electrode body;
a laminated sheet covering the electrode body and a portion of the charge collection terminal at another side in the first direction; and
a tab film that is interposed between the charge collection terminal and the laminated sheet, that is formed with a projection portion that protrudes out from a corner portion provided at the charge collection terminal at an end portion in a second direction orthogonal to the first direction and to a thickness direction of the charge collection terminal, and that is welded to the charge collection terminal and the laminated sheet at a periphery of the charge collection terminal.

4. A tab film cutting method comprising:
disposing a first film above a plate-shaped charge collection terminal;
disposing an upper jig above the first film;
disposing a second film below the charge collection terminal;
disposing a lower jig below the second film;
disposing a first lateral jig provided with first projection portions protruding in upward and downward directions at one side with respect to the charge collection terminal in a second direction orthogonal to a thickness direction of the charge collection terminal as viewed along the first direction and to the first direction;
temporarily fixing a third film to a portion of the first lateral jig at another side in the second direction such that the third film is in a curved or bent state so as to be convex on a charge collection terminal side;
disposing a second lateral jig provided with second projection portions protruding in the upward and the downward directions at the other side in the second direction with respect to the charge collection terminal; and
in a state in which a fourth film is temporarily fixed to a portion of the second lateral jig at the second direction one side such that the fourth film is in a curved or bent state so as to be convex on the charge collection terminal side,
pressing with a hot press from above the upper jig and below the lower jig.
